(19) United States
(12) Patent Application Publication
(10) Pub. No.: US 2008/0095912 A1
(43) Pub. Date: Apr. 24, 2008

(54) Portable caffeine detector and method of detecting caffeine in a beverage

(76) Inventor: Emmett Loughran, Dix Hills, NY (US)

Correspondence Address: BREGEN TECHNICAL CONSULTANTS L.L.C., 154 OLD CLINTON ROAD, FLEMINGTON, NJ, 08822, US

(21) Appl. No.: 11/584,169

(22) Filed: Oct. 21, 2006

(51) Int. Cl. A23F 3/00

(52) U.S. Cl. 426/597

(57) ABSTRACT

An aspect of this invention is a portable caffeine detector, which is optionally called The De-Caf Stick. It is a test strip that is inexpensive, is safe and easy to use, may be carried in a pocket, briefcase, computer case, handbag or the hand and can be used to determine the presence or absence of caffeine in both hot and cold beverages before they are consumed. The caffeine detector is disposable and, preferentially, is made of biodegradable polymeric materials. The results of the tests can be detected calorimetrically, without the use of instrumentation or reagents. Another aspect of the invention is a carrying case for holding a plurality of the test strips. A further aspect of the invention is a method of detecting caffeine in a beverage using the portable test strips.

### BACKGROUND OF THE INVENTION

1. Field of the Invention

This invention relates to a portable, disposable device for detecting the presence or absence of caffeine in a beverage and a method for using the device. More specifically, the beverage can be coffee, a coffee drink, tea, a soft drink, or any other beverage suspected of containing caffeine. The testing device is such that it can be used at the time of service by a consumer, a server, or another interested person.

2. Description of Related Art

Caffeine is the common name for trimethylxanthine, a molecule first isolated by the German chemist Friedrich Ferdinand Runge in 1819. It is also known as coffeine, theine, mateine, guaranine, or methyltheobromine. Caffeine is naturally produced by several plants, including coffee beans, guarana, yerba mate (accent), cacao beans and tea. For the plants, caffeine acts as a natural pesticide. It paralyzes and kills insects that attempt to feed on the plants. When purified, caffeine is an intensely bitter white powder. It is added to colas and other soft drinks to impart a pleasing bitter note. However, caffeine is also an addictive stimulant.

In humans, it stimulates the central nervous system, heart rate, and respiration, has psychotropic (mood altering) properties, and acts as a mild diuretic. With more than half of all American adults consuming more than 300 mg of caffeine every day, caffeine is the most popular drug. Caffeine is generally consumed in coffee, cola, chocolate, and tea, although it is also available over-the-counter as a stimulant.

Some individuals are advised to avoid caffeine in their diet because of the danger of adverse health effects for them. For example, pregnant women, individuals with ulcers and individuals with Epstein-Barr Virus can be adversely affected by caffeine. In addition, some people are allergic to caffeine. Others choose not to expose themselves to the mood-altering effects of caffeine or the resultant sleeplessness that comes from drinking caffeine at night.

Caffeine is usually quickly and completely removed from the brain. Its effects are short-lived and it tends not to negatively affect concentration or higher brain functions. However, continued exposure to caffeine leads to developing a tolerance to it. Tolerance causes the body to become sensitized to adenosine, so withdrawal causes blood pressure to drop, which can result in a headache and other symptoms. Too much caffeine can result in caffeine intoxication, which is characterized by nervousness, excitement, increased urination, insomnia, flushed face, cold hands and/or feet, intestinal complaints, and sometimes hallucinations. Some people experience the symptoms of caffeine intoxication after ingesting as little as 250 mg per day. The lethal ingested dose, for an adult person, is estimated to be 13-19 grams. While generally considered safe for people, caffeine can be very toxic to household pets, such as dogs, horses, or parrots. Caffeine intake has been demonstrated to reduce the risk of type II diabetes mellitus. In addition to use as a stimulant and flavoring agent, caffeine is included in many over-the-counter headache remedies.

Doses of over 750 mg (7 cups of coffee) can produce a reaction similar to an anxiety attack, including delirium, ringing ears, and light flashes. These amounts of caffeine may come from a single dose or from multiple doses at short intervals.

Decaffeinated coffees, teas and sodas are routinely made available to individuals who must abstain from ingesting caffeine and those who choose not to use it. But errors can happen in busy establishments, in spite of carefully set procedures and policies. Carafes and cups can be switched. Servers can inadvertently make mistakes. There is a need for a fast, safe, simple-to-use, on-site method of enabling a person to detect the presence, above a threshold amount, or absence of caffeine in a beverage at the point of service, before consumption.

Numerous methods of determining the presence of caffeine in various media are well-known to analytical chemists and others skilled in the art. For example, the scientific literature includes test methods such as an electrometric determination in which a caffeine-specific electrode is prepared from a caffeine-picrylsulfonate ion-pair complex dissolved in octanol; a fluorimetric determination in which a buffered solution of caffeine is oxidized with N-bromosuccinimide and then reacted with dimethyl o-phenylenediamine followed by a fluorescence measurement at 480 nm; a calorimetric determination in which an ethenolic solution of caffeine is oxidized by potassium bromate, dried and then redissolved in dimethylformamide followed by an absorbance measurement at 500 nm; a Fourier Transform Infrared Spectrophotometry (FTIR) assay; a thin-layer/gas chromatographic test method; enzyme-linked immunosorbent caffeine assays, in which a caffeine-containing sample of plasma or serum is dissolved in a buffered solution and incubated in a vessel where it competes with peroxidase-labeled caffeine for the binding sites on caffeine antibodies followed by detection of a visible color change with the addition of o-phenylenediamine; and an immunoassay of theophylline with cross-sensitivity for caffeine.

In addition, a rapid method for detecting the presence of caffeine using thin layer chromatography is disclosed in Alpdoan, G. Turk. J. Chem. 26 (2002), 295-302. Further, a caffeine detector using molecular imprint polymers in an assay is disclosed in U.S. Pat. No. 6,461,873 (Catania, D.).

Several devices or methods have been reported in the patent literature that enable the consumer or server to ensure that the beverage they think is decaffeinated really is before the drink is consumed. U.S. Pat. No. 6,153,147 (Craig, J.), U.S. Pat. No. 5,817,454 (Harris, S.), US 20010009758 (Harris, S.), US 2003/0111003 (Engleman, J.), US 2002/0192834 (Sand, B.), U.S. Pat. No. 5,610,072 (Scherl, M.), US2004115092 (Starr, P.), WO9627795 (Mitchell, A.) and U.S. Pat. No. 6,500,665 (Deegan, J.) all claim portable means of testing a beverage for the presence of caffeine and, in some cases, other molecules.

A need exists for an assay that can be used at the point of service, before consumption, to determine the presence or absence of caffeine in a beverage portion without adulterating the portion, or a significant amount thereof This method and the device used in testing should be safe, portable, easy-to-use, should require no reagents and should be readily disposable.

### BRIEF SUMMARY OF THE INVENTION

An aspect of this invention is a portable caffeine detector, which is optionally called The De-Caf Stick. It is a test strip that is inexpensive, is safe and easy to use, may be carried in a pocket, briefcase, computer case, handbag or the hand and can be used to determine the presence or absence of caffeine in both hot and cold beverages before they are consumed. The caffeine detector is disposable and, preferentially, is made of biodegradable polymeric materials. The results of the tests can be detected calorimetrically, without the use of instrumentation or reagents. Another aspect of the invention is a carrying case for holding a plurality of the test strips. A further aspect of the invention is a method of detecting caffeine in a beverage using the portable test strips.

### BRIEF DESCRIPTION OF THE DRAWINGS

FIG. 1 depicts a first embodiment of the invention.

FIG. 2 depicts a second embodiment of the invention in which two test areas are present, one in which a color change indicates the presence of caffeine and one in which a color change indicates the absence of a threshold of caffeine.

FIG. 3 depicts an embodiment of the invention wherein a material comprised of a chromophore indicating either the presence or absence of caffeine in a beverage is affixed to one area of the test strip.

FIG. 4 depicts an embodiment of the invention in which two areas of the test strip have affixed to them material comprised of a chromophore, one wherein a color change indicates the presence of caffeine and one wherein the absence of a color change indicates the absence of a threshold of caffeine.

### DETAILED DESCRIPTION OF THE INVENTION

An aspect of this invention is a portable caffeine detector, a test strip 10, which may be referred to as “The De-Caf Stick”, which serves as a portable device to detect caffeine in a beverage at the point of service, before the beverage is consumed. The test strip can be any appropriate size and shape. It can be tapered, blunt, or pointed at one or both ends. It is both flexible and sturdy. The test strip 10 may be comprised of any suitable material, such as a polymer, copolymer or blend; a porous wood, such as orangewood, birchwood, and basswood; cardboard; or a sturdy weight of paper. Preferentially, the test strip 10 is comprised of a biodegradable polymer, copolymer or blend, such as poly (lactic acid) (PLA), polycaprolactone (PCL), or polyhydroxybutyrate-valerate (PHBV) and their copolymers.

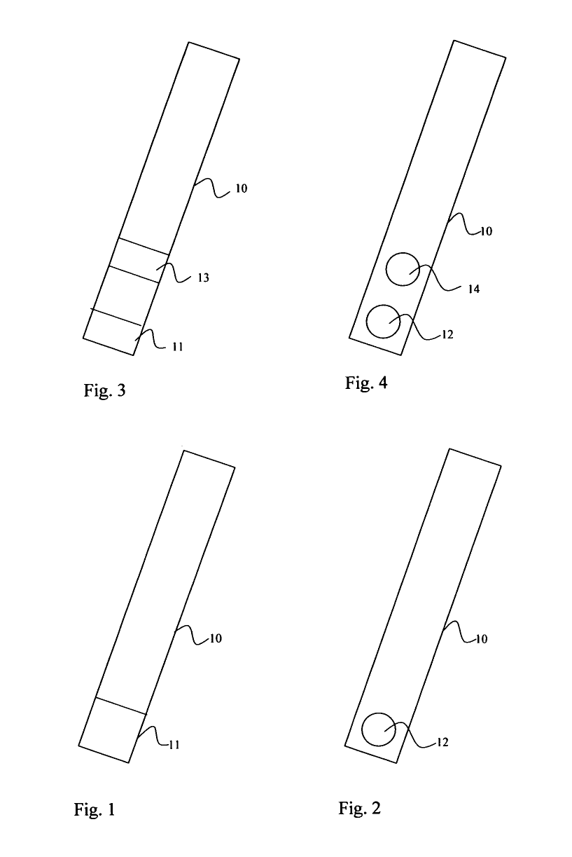

FIG. 1 depicts an embodiment of the invention, wherein at least one area of the test strip 10 comprises a substance that changes color to indicate the presence of absence of a threshold amount of caffeine in a beverage. This substance, a chromophore, is added to the test strip in least one area 11 by impregnating an area of the test strip with it F or by incorporating the chromophore into the polymer during its preparation. The chromophore may be phosphomolybdic acid, peroxidase, potassium iodide chromogen, tetramethylbenzidine, homovanillic acid or any other chemical or biological substance available to those skilled in the art that will change color when coming into contact with a threshold amount of caffeine in a beverage or, alternatively, when detecting no caffeine above a threshold amount in the beverage. The beverage may be hot, room temperature, or cold.

FIG. 2 depicts another embodiment, wherein at least one area of the test strip 10 comprises a chromophore that changes color to indicate the presence of absence of a threshold amount of caffeine in a beverage. This chromophore is added to the test strip by affixing a material comprised of the chromophore to at least one area 12 of the test strip. The chromophore may be phosphomolybdic acid, peroxidase, potassium iodide chromogen, tetramethylbenzidine, homovanillic acid or any other chemical or biological substance available to those skilled in the art that will change color when coming into contact with a threshold amount of caffeine in a beverage or, alternatively, when detecting no caffeine above a threshold amount in the beverage. The beverage may be hot, room temperature, or cold.

FIG. 3 and FIG. 4 depict further embodiments of the invention, in which at least one area of the test strip 13 is impregnated with a chromophore that changes color in the absence of a threshold amount of caffeine or, alternatively, has a material containing the chromophore affixed to an area 14 of the test strip. The chromophore changing color upon the absence of a threshold amount of caffeine in a beverage, which is selected from those chromophores known to one skilled in the art, can be used instead of the chromophore detecting the presence of caffeine in a beverage or can be used in conjunction with the chromophore detecting the presence of caffeine by being present in another area of the same test strip.

The test strip optionally comprises indicia stating the presence of caffeine or absence of caffeine in the beverage.

Another aspect of the invention is a portable container for holding a plurality of test strips. The container is of a size that can fit in an adult's hand, pocket, a briefcase, a computer case or a handbag. The portable container opens on top, allowing one test strip to be removed at a time. The case keeps the test strips clean, dry and readily available for use.

Still another aspect of the invention is a method of detecting caffeine in a beverage whereby a consumer, server or other interested person takes one test strip out of its carrying case, dips it into the beverage suspected of containing caffeine, removes the test strip, waits a length of time less than 20 seconds, and observes whether a change in color appears in the area or areas of the strip containing the chromophore or chromophores detecting the presence or absence of a threshold amount of caffeine.

Alternatively, the consumer, server or other interested party can take a test strip out of the portable container, place it on any dry, flat surface, such as the hand, a table or saucer, and taking a finger, stirrer, straw, spoon or other implement, removes one or more drops of the beverage and places it on the area or areas of the test strip containing the chromophore or chromophores. Upon waiting a length of time less than 20 seconds, he/she observes whether a change in color appears in the area or areas of the test strip containing the chromophore or chromophores.

This invention claims:

1. A portable device for detecting the presence or absence of caffeine in a beverage comprising:
a test strip;
said strip having a first area comprising a chromophore for detecting either the presence or absence of caffeine;
said strip having, optionally, indicia near the first area.

2. A portable device for detecting the presence or absence of caffeine in a beverage comprising:
a test strip;
said strip having a first area comprising a chromophore for detecting the presence of caffeine;
said strip having a second area comprising a chromophore for detecting the absence of caffeine;
said strip having, optionally, indicia near the first and/or the second areas impregnated with a chromophore or chromophores.

3. The portable device of claim 1, wherein the test strip is comprised of a biodegradable material.

4. The portable device of claim 1, wherein the test strip is comprised of a biodegradable polymer.

5. The portable device of claim 2, wherein the test strip is comprised of a biodegradable material.

6. The portable device of claim 2, wherein the test strip is comprised of a biodegradable polymer.

7. A method for detecting the presence or absence of caffeine in a beverage using the device of claim 1, comprising the steps:
a. dipping the test strip momentarily into a beverage suspected of containing caffeine;
b. removing the test strip from the beverage;
c. observing whether or not a color change takes place in the area or areas of the test strip comprising the chromophore or chromophores.

8. A method for detecting the presence or absence of caffeine in a beverage using the device of claim 1, comprising the steps:
b. removing one or more drops of a beverage suspected of containing caffeine from its container using one item taken from the group of a stirrer, spoon, straw, and one's finger;
c. putting the drop or drops of beverage suspected of containing caffeine onto the area or areas of the test strip comrising the chromophore or chromophores;
d. observing whether or not a color change takes place in the area or areas of the test strip containing the chromophore or chromophores.

9. A method for detecting the presence or absence of caffeine in a beverage using the device of claim 2, comprising the steps:
a. dipping the test strip momentarily into a beverage suspected of containing caffeine;
b. removing the test strip from the beverage;
c. observing whether or not a color change takes place in the area or areas of the test strip comprising the chromophore or chromophores.

10. A method for detecting the presence or absence of caffeine in a beverage using the device of claim 2, comprising the steps:
b. removing one or more drops of a beverage suspected of containing caffeine from its container using one item taken from the group of a stirrer, spoon, straw, and one's finger;
c. putting the drop or drops of beverage suspected of containing caffeine onto the area or areas of the test strip comrising the chromophore or chromophores;
d. observing whether or not a color change takes place in the area or areas of the test strip containing the chromophore or chromophores.

11. A portable container of a size large enough to hold a plurality of the test strips of claim 1, comprising:
a container with a lid;
said lid remaining attached to the container when opened;
said lid having an opening
said opening is of a size allowing at least one test strip of claim 1 be removed from the container at a time
said container is further of a size that can be carried in the adult hand or be placed in a briefcase, handbag, computer case.

12. A portable container of a size large enough to hold a plurality of the test strips of claim 2, comprising:
a container with a lid;
said lid remaining attached to the container when opened;
said lid having an opening
said opening is of a size allowing at least one test strip of claim 2 be removed from the container at a time
said container is further of a size that can be carried in the adult hand or be placed in a briefcase, handbag, computer case.
